(19) United States
(12) Patent Application Publication
(10) Pub. No.: US 2009/0191026 A1
(43) Pub. Date: Jul. 30, 2009

(54) Round bale handling apparatus

(76) Inventor: Billy Joe Hobbs, Rockdale, TX (US)

Correspondence Address: Donald M. Marshall, P.O. Box 104, Pendleton, TX, 76564, US

(21) Appl. No.: 12/318,921

(22) Filed: Jan. 12, 2009

Related U.S. Application Data
(60) Provisional application No. 61/020,742, filed on Jan. 13, 2008.

(51) Int. Cl. A01D 87/12

(52) U.S. Cl. 414/24.5

(57) ABSTRACT

An apparatus for handling and transporting round bales. The apparatus can be mounted on the back of flatbed truck. The hay spear is retractable such that the truck can be attached to a trailer without dismounting the device. The hay spear contains two spikes that straddles the ball hitch. The spikes are attached to a shaft which is mounted to the backend to of the truck bed. The mechanism is mounted with four solid bearings such that it can rotate 190 degrees. On the right side of the truck beds surface is a mounted hydraulic cylinder with a piston. The piston is attached to a double solid bearing linkage bar for lifting and transporting large bales of hay.

### CROSS-REFERENCE TO RELATED APPLICATIONS

This application claims the benefit of and priority to provisional U.S. Patent Application No. 61/020,742, filed 13 Jan., 2008 and entitled “HayTech Hayspear.”

### FIELD OF THE INVENTION

This invention generally pertains to farm equipment and describes an apparatus and a process which may be used for the handling, stacking and transportation of large bales of hay.

### BACKGROUND OF THE INVENTION

For large producers of hay in arid climates, it is more economical to bale the hay in large cylindrical and/or rectangular shaped bales than smaller traditionally sized bales. The large rectangular bales typically weigh approximately eighteen hundred (1800) pounds and have dimensions of approximately four (4) feet by four (4) feet. The bales can also be approximately three (3) feet by four (4) feet by eight (8) feet.

A current problem is how to handle, transport, stack these large bales. The current handlers and transporters for large cylindrical and rectangular shaped bales are specially built and dedicated vehicles which can generally only be used to pick up and stack hay bales and since they do not perform any other functions, they are not as economical as if they could be used for other trucking functions.

The existing transporters are generally manufactured by starting with a standard truck/vehicle chassis, building a cab which only spans part of the width of the vehicle so that the vehicle can receive bales from the front of the vehicle as it drives through a hayed field.

Because the existing bale handlers and transporters require substantial modification or additions to an existing chassis and therefore become dedicated to one use, i.e. bale loading and transporting, they are unnecessarily expensive, cost prohibitive and have no versatility.

This invention solves the forenamed problems by providing a large bale handler and transporter which can easily and relatively inexpensively be placed on existing general use flat bed vehicles. In solving the forenamed problems and others, this invention utilizes a pivoting linkage bar system to pick up, transport and stack large bales of hay without the need to substantially modify an existing vehicle and without the need to dedicate the modified vehicle to one use.

This invention solves the forenamed problems in such a way that the handling and transporting of hay is accomplished efficiently, economically and expeditiously.

### SUMMARY OF THE INVENTION

This invention generally pertains to an apparatus and process which provides a large bale handler, stacker and transporter, and more particularly provides a versatile large bale transporter which picks up and stacks large hay bales. This invention further includes a rotatable lifting and stacking pivoting bar mechanism that can attach to and lift the large bale and place it on the flatbed portion of the vehicle.

It is an object of this invention to provide a large hay bale handler and transporter which can be manufactured much more economically than those currently being used. This invention accomplishes this by utilizing a double pivoting linkage bar system which can readily be attached and adapted to existing vehicles, thereby eliminating the costs inherent in substantially modifying existing vehicles and dedicating the vehicle to use only for large bale handling and transportation.

### BRIEF DESCRIPTION OF THE DRAWINGS

FIG. 1 illustrates a perspective view of two pointed spikes in accordance with embodiments of the present invention.

FIG. 1 illustrates a perspective view of the rotating shaft mechanism in accordance with embodiments of the present invention.

FIG. 1 illustrates a perspective view of the solid bearing assembly in accordance with embodiments of the present invention.

FIG. 1 illustrates a perspective view of the hydraulic cylinder with piston in accordance with embodiments of the present invention.

FIG. 1 illustrates a perspective view of the first end solid bearing linkage bar in accordance with embodiments of the present invention.

FIG. 1 illustrates a perspective view of the second end solid bearing linkage bar in accordance with embodiments of the present invention.

FIG. 1 illustrates a perspective view of the first leverage bar in accordance with embodiments of the present invention.

FIG. 1 illustrates a perspective view of the second leverage bar in accordance with embodiments of the present invention.

### DETAILED DESCRIPTION OF EMBODIMENTS

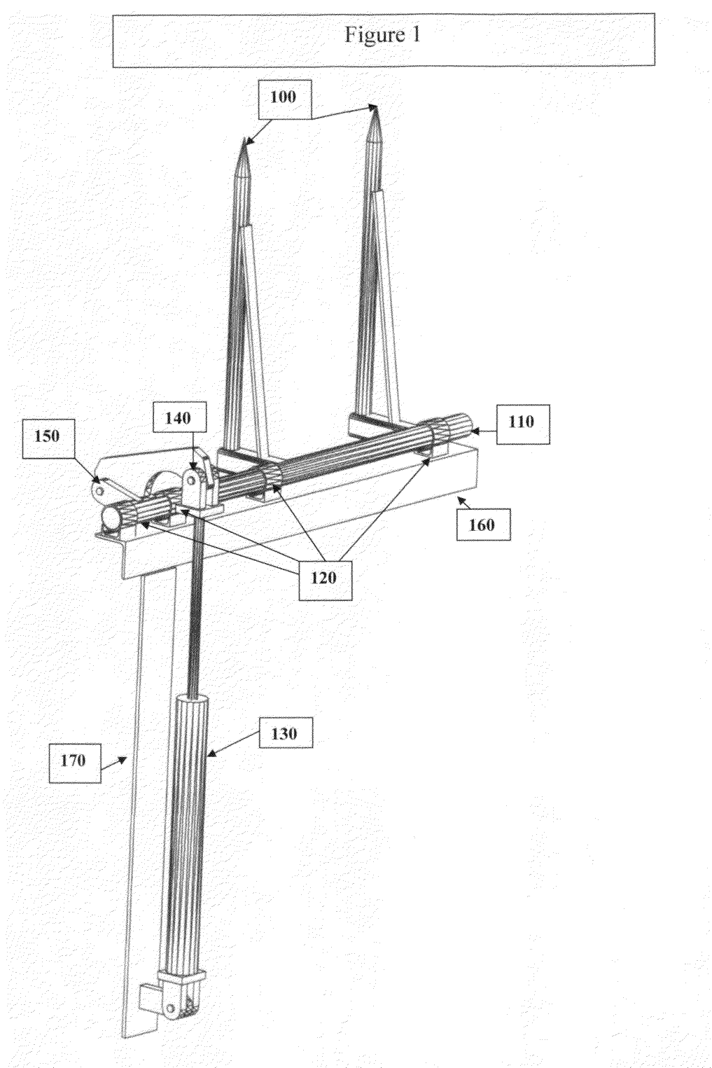

FIG. 1 illustrates hay spear device which can be mounted on the back of flatbed truck. The hay spear is retractable such that the truck can be attached to a trailer without dismounting the device. The hay spear contains two spikes (100) that straddles the ball hitch. The spikes are attached to a shaft (110) which is mounted to the backend to of the truck bed. The mechanism is mounted with four solid bearings (120) such that it can rotate 190 degrees. On the right side of the truck beds surface is a mounted hydraulic cylinder with a piston (130). The piston is attached to a double solid bearing linkage bar. On one end of the linkage bar (140) is the previously mentioned piston, with an attached rotating shaft (150) at the opposite end. At this location are two leverage bars (160) & (170) that are welded to the shaft. When lifting up or down, the linkage bar pivots in two places: at the piston (140) and at the leverage bar's connection (150) to the rotating shaft. The double pivoting linkage bar system makes it possible for the rotating shaft to rotate 190 degrees. In the upright rotation position, the spikes (100) will lay flush to the bed of the truck, thus making it possible to connect a gooseneck trailer to the truck, or rotate outward to the back end of the truck bed, to pick up round bales of hay. This piston (130) is mounted on the right side of the truck bed such that the trucks bed surface is unobstructed.

While exemplary embodiments of the invention have been shown and described, such embodiments are not intended to be limiting. Modifications of the described embodiments can be made by on skilled in the art without departing from the spirit and teachings of the invention. Many variations are possible and within the scope of the invention. Use of broader terms such as comprises, includes, having, ect. should be understood to be open ended. The scope of protection is not limited by the description set out above, but is only limited by the claims that follow, that scope including all equivalents of the subject matter of the claim.

1. A double pivoting linkage bar system makes is possible for the rotating shaft to rotate 190 degrees.

2. The spikes will lay flush to the bed of the truck in the upright position, thus making it possible to connect a gooseneck trailer to the truck.

3. The spikes rotate outward to the back end of the truck bed, to pick up round bales of hay.

4. The hay spear is retractable such that a trailer can be attached to a truck without dismounting the device.
